(19) United States
(12) Patent Application Publication
(10) Pub. No.: US 2008/0183980 A1
(43) Pub. Date: Jul. 31, 2008

(54) Method and system for locking data of program memory embedded in microcontroller

(75) Inventors: Chun-Ming Lin, Hsinchu City (TW); Chien-Po Yang, Keelung City (TW)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: HOLTEK SEMICONDUCTOR, INC., Hsinchu (TW)

(21) Appl. No.: 11/808,665

(22) Filed: Jun. 12, 2007

(30) Foreign Application Priority Data
Jan. 26, 2007 (TW) 96103037

(51) Int. Cl. G06F 12/00

(52) U.S. Cl. 711/154; 711/E12.001

(57) ABSTRACT

A method for locking data of a program memory embedded in a microcontroller is provided. The method keeps the data stored in the program memory from being dumped. The program memory consists of a one-time-programmable read only memory and is configured into a plurality of storage sectors. The method, according to the present invention, first receives a lock command in which the lock command corresponds to a specific storage sector of the program memory. Next, according to the lock command, which storage sector is the specific sector is recognized. Finally, an access lock module is activated for locking the specific storage sector.

### BACKGROUND OF THE INVENTION

1. Field of the Invention

The present invention is related to a method for locking data for a program's memory, and more particular to a method and a system for locking data for a program memory which is embedded in a microcontroller.

2. Description of Related Art

Microcontrollers are widely applied in conventional products, vehicle electronics, computer systems, communication systems and industrial facilities. A program memory embedded in a microcontroller is used to store firmware. The firmware is the logical core and controls the peripheral components of the applied device. Thus, the firmware is an important intellectual property, and the program memory storing the firmware should have a locking and protecting function for preventing the firmware from being dumped through the interface of the microcontroller.

Generally speaking, storing firmware via a one-time-programmable (OTP) read only memory protects the firmware from being dumped very effectively. However, the current method for locking data for a program's memory consisting of a one-time-programmable read only memory is whole chip locking. Once the program memory is locked, the data stored therein cannot be read out anymore. Before lock protection is performed, the entire data should be written into the microcontroller. In other words, the data in the microcontroller cannot be overwritten due to the whole chip locking of the program memory. Moreover, one or more external EEPROMs usually have to be used in practical application when the program memory of the microcontroller consists of a one-time-programmable read only memory for recoding product information, such as calibration references and series numbers.

As the application of microcontrollers increases and the requirements for updating the firmware and software of products appears, flash memory is becoming a major material for forming program memory. Flash memory includes a partial data locking function. The partial data locking divides the flash memory into a plurality of storage sectors, and locks a specific storage sector after data has been written into the storage sector so as to prevent data stored in the specific storage sector from being dumped. U.S. Pat. Nos. 6,031,757 and 6,879,518 both disclose partial data locking for a flash memory.

However, the partial data locking of flash memory locks a storage sector mainly by software. When there is a requirement for updating the firmware, the software can generate a decryption command to interrupt the data locking of the storage sector. Through this mechanism, the software can un-lock the locked storage sector, and the firmware can be read out. Thus, the firmware might be dumped.

Therefore, the inventor offers the present invention for overcoming the prior art problems. The present invention provides a mechanism for locking data of a program memory embedded in a microcontroller that makes the application of a program memory much more flexible.

### SUMMARY OF THE INVENTION

Accordingly, the scope of the present invention provides a method and system for locking data of a program's memory embedded in a microcontroller that makes the application of a program memory more flexible by locking the storage sectors of the program memory individually.

The present invention provides a method for locking data of a program memory embedded in a microcontroller. The program memory consists of a one-time-programmable read only memory and is configured into a plurality of storage sectors. The method, according to the present invention, firstly receives a lock command in which the lock command corresponds to a specific storage sector of the program memory. Next, according to the lock command, which storage sector is the specific storage sector is recognized. Lastly, an access lock module is activated for locking a specific storage sector. Thus the specific storage sector is able to keep the data stored therein from being dumped.

The present invention further provides a method for locking data of a program memory embedded in a microcontroller. The program memory consists of a one-time-programmable read only memory and is configured into a plurality of storage sectors. The method, according to the present invention, firstly receives a lock command in which the lock command corresponds to a specific storage sector of the program memory. Next, according to the lock command, which storage sector is the specific storage sector is recognized. Lastly, an access lock module is activated for locking the specific storage sector. The access lock module comprises a plurality of locking circuits, wherein each locking circuit corresponds to one storage sector and comprises of at least one locking bit respectively. The state of the locking bit determines whether the storage sector is locked. Thus the specific storage sector is able to keep the data stored therein from being dumped.

The present invention further provides a method for locking data of a program memory embedded in a microcontroller executed by a system for locking data of the program memory of the microcontroller. The system comprises a data inputting device and a microcontroller. The microcontroller comprises a program memory, an access lock module and a command processing module in which the command processing module comprises a plurality of locking circuits. The program memory consists of a one-time-programmable read only memory and is configured into a plurality of storage sectors. The method, according to the present invention, includes the following steps. Firstly, the command processing module receives a lock command generated from the data inputting device in which the lock command corresponds to a specific storage sector of the program memory. Next, according to the lock command, which storage sector is the specific storage sector is recognized. Lastly, a specific locking circuit of the access lock module is activated in which the specific locking circuit corresponds to the specific storage sector for keeping the data stored therein from being dumped.

The present invention further provides a system for locking data of a program memory embedded in a microcontroller. The system comprises a data inputting device, and a microcontroller. The microcontroller is coupled to the data inputting device and comprises a program memory, an access lock module, and a command processing module. The data inputting device generates a lock command. The program memory consists of a one-time-programmable read only memory and is configured into a plurality of storage sectors. The access lock module is coupled to the program memory. The command processing module is coupled to the access lock module. The command processing module receives the lock command generated from the data inputting device in which the lock command corresponds to a specific storage sector of the program memory. The command processing module recognizes the specific storage sector in accordance with the lock command, and further activates the access lock module for locking the specific storage sector for keeping the data stored therein from being dumped.

In one embodiment of the present invention, the access lock module comprises a plurality of locking circuits and each locking circuit corresponds to a storage sector of the program memory respectively. The access lock module activates a specific locking circuit corresponding to the specific storage sector for keeping the data stored therein from being dumped.

The present invention further provides a microcontroller comprising a program memory, an access lock module, and a command processing module. The program memory consists of a one-time-programmable read only memory and is configured into a plurality of storage sectors. The access lock module is coupled to the program memory. The command processing module is coupled to the access lock module. The command processing module receives a lock command in which the lock command corresponds to a specific storage sector of the program memory. The command processing module recognizes the specific storage sector in accordance with the lock command, and further activates the access lock module for locking the specific storage sector for keeping the data stored therein from being dumped.

In one embodiment of the present invention, the access lock module comprises a plurality of locking circuits and each locking circuit corresponds to a storage sector of the program memory respectively. The access lock module activates a specific locking circuit corresponding to the specific storage sector for keeping the data stored therein from being dumped. The locking circuit comprises at least one locking bit respectively and the state of the locking bit determines whether the storage sector is locked.

In one embodiment of the present invention, the microcontroller is coupled to a data inputting device, and the lock command is generated from the data inputting device.

The objective of the present invention will no doubt become obvious to those of ordinary skill in the art after reading the following detailed description of the preferred embodiment, which is illustrated in the various figures and drawings.

### BRIEF DESCRIPTION OF THE DRAWINGS

FIG. 1 is a block diagram of the system for locking data of a program memory embedded in a microcontroller according to the present invention;

FIG. 2 is a block diagram of an embodiment of the system for locking data of a program memory embedded in a microcontroller according to the present invention;

FIG. 3 is a block diagram of another embodiment of the system for locking data of a program memory embedded in a microcontroller according to the present invention;

FIG. 4 is a flow chart of the method for locking data of a program memory embedded in a microcontroller according to the present invention; and

FIG. 5 illustrates an example of applying the method and system for locking data of a program memory embedded in a microcontroller according to the present invention.

### DETAILED DESCRIPTION OF THE PREFERRED EMBODIMENTS

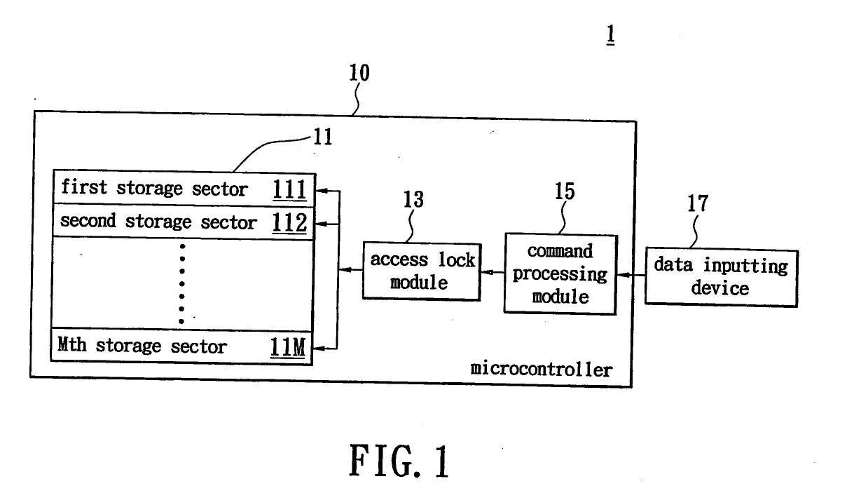

Please refer to FIG. 1 which illustrates a block diagram of the system 1 for locking data of a program memory 11 embedded in a microcontroller 10 according to the present invention. The system 1 locks the program memory 11 of the microcontroller 10 for keeping the data stored therein from being dumped.

As shown in FIG. 1, therein the microcontroller 10 includes the program memory 11, an access lock module 13, and a command processing module 15. The program memory 11 consists of a one-time-programmable read only memory. The program memory 11 is configured into an M storage sector, including a first storage sector 111, a second storage sector 112, and so on. M is an integer larger than 1. The access lock module 13 is coupled to the program memory 11, and is able to lock the storage sector (111, 112, and so on) individually for keeping the data stored therein from being dumped. Once any of the storage sectors is locked, the data stored therein cannot be dumped via the interface of the microcontroller 10.

As shown in FIG. 1, the system 1 includes a data inputting device 17 and a command processing module coupled to the data inputting device 17 for receiving a lock command. The lock command corresponds to a specific storage sector of the storage sectors (111, 112, and so on). According to the lock command, the command processing module 15 recognizes which storage sector is the specific storage sector and activates the access lock module 13 to lock the specific storage sector for keeping the data stored therein from being dumped.

The data inputting device 17 is a device for writing firmware onto the microcontroller 10. In general, the data inputting device 17 communicates with the microcontroller 10 by executing a burn program in a computer system. A user inputs the firmware into one storage sector via the data inputting device 17, and transmits a lock command to the microcontroller 10. The command processing module 15 is an arithmetic logic unit. The command processing module 15 recognizes the address of the specific storage sector corresponding to the lock command and activates the access lock module 13 to lock the specific storage sector.

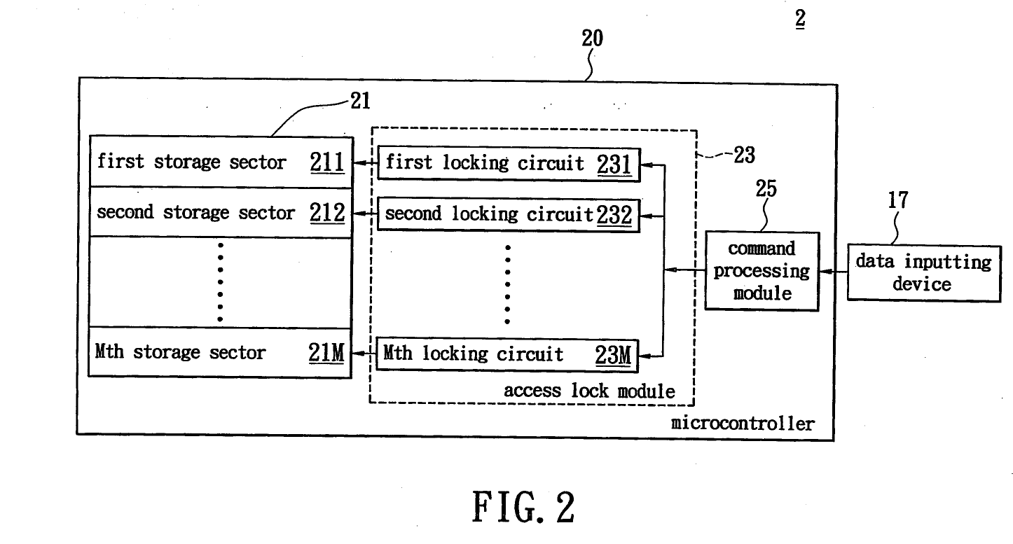

Please refer to FIG. 2 which illustrates a block diagram of an embodiment of the system 2 for locking data of a program memory embedded in a microcontroller according to the present invention. As shown in FIG. 2, a microcontroller 20 includes a program memory 20, an access lock module 23, and a command processing module 25. The access lock module 23 includes M locking circuits, including a first locking circuit 231, a second locking circuit 232, and so on. Each locking circuit corresponds to one storage sector of the storage sectors (231, 232, and so on). The activation of the locking circuit locks the corresponding storage sector to keep the data stored therein from being dumped. After receiving the lock command generated by the data inputting device 17, the command processing module 25 recognizes which storage sector is the specific storage sector and further activates the corresponding locking circuit of the specific storage sector for locking the specific storage sector.

Furthermore, each locking circuit (231, 232, and so on) includes at least one locking bit. The state set within the locking bit determines whether the storage sector is locked. In other words, the activation of the specific locking circuit sets the locking bit within the activated specific locking circuit to lock the specific storage sector.

For example, a user transmits a lock command into the microcontroller 20 by the data inputting device 17 for a locking first storage sector 211. After receiving the lock command, the command processing module 25 recognizes the lock command corresponding to the first storage sector 211, and activates the locking bit within the first locking circuit 231 for locking the first storage sector 211.

Because the protect mechanism for keeping the data stored in the program memory from being dumped is well known, the detailed technology about the protect mechanism will not be mentioned again herein. Moreover, the locking bits of locking circuit (231, 232, and so on) can also be implemented by one-time-programmable read only memory. Then, once the locking bit is activated, it is difficult to un-lock the activated locking bits unless an ultraviolet ray is applied thereto. However, if an ultraviolet ray is applied, the program memory will be erased at the same time, and the data stored therein will be erased.

Note that the microcontroller 20 herein is implemented by an integrated circuit chip. For preventing the activated locking circuits from being un-locked, the locking bits belonging to the locking circuits can be distributed onto the chip microcontroller 20 implemented thereon by an integrated circuit layout design which prevents the position of the locking bits from being recognized easily. Therefore, it is difficult to dump the firmware of the microcontroller 20. Furthermore, each storage sector (231, 232, and so on) corresponds to at least one locking bit. The more locking bits one storage sector corresponds to, the more difficult it is to recognize the distribution of all the locking bits. Therefore, it is even more difficult to dump the firmware of the microcontroller 20.

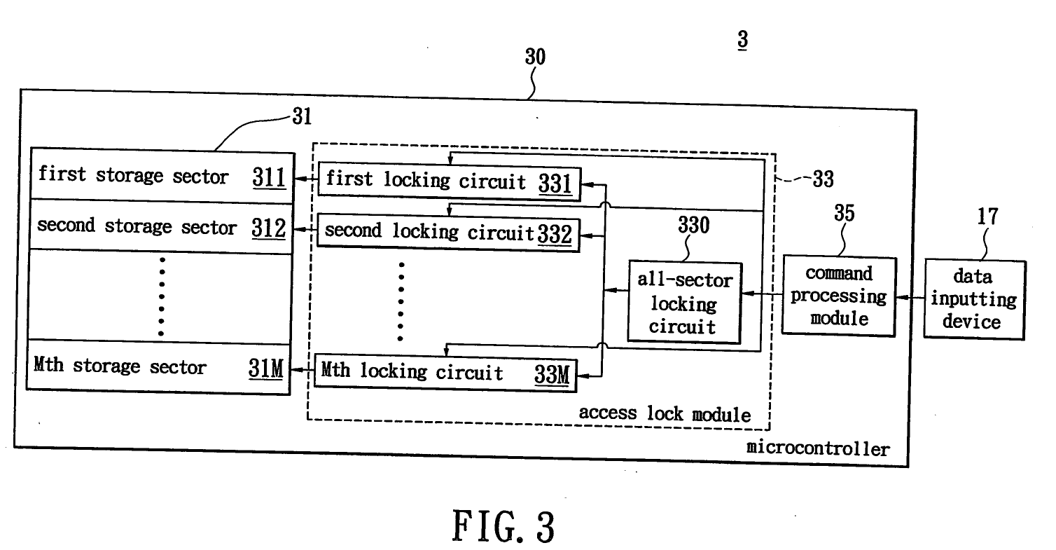

Please refer to FIG. 3 that illustrates a block diagram of another embodiment of the system for locking data of a program memory embedded in a microcontroller according to the present invention. The difference between the embodiments illustrated in FIG. 2 and FIG. 3 is that an access lock module 33 further comprises an all-sector locking circuit 330. The system 3 can lock all the storage sectors (311, 312, and so on) at the same time. While the lock command transmitted from the data inputting device 17 asks to lock all storage sectors of a program memory 31, a command processing module 35 drives an all-sector locking circuit 330 to activate all the locking circuits (331, 332, and so on) to lock all the storage sectors (311, 312, and so on) after it has received and recognized the lock command.

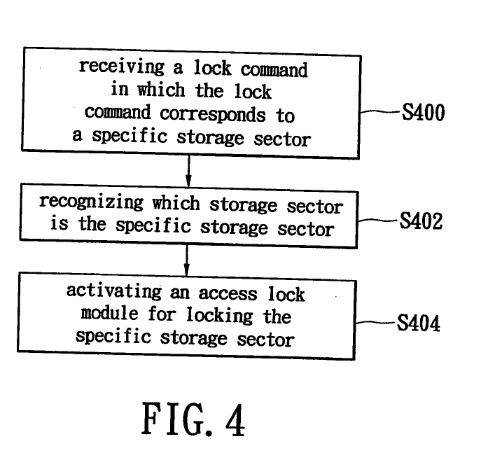

Please refer to FIG. 4 which illustrates a flow chart of the method for locking data of a program memory embedded in a microcontroller according to the present invention. Please refer to FIG. 1 for the elements mentioned hereafter. As shown in FIG. 4, the method includes the following steps.

Firstly, S400 is performed. The command processing module 15 receives a lock command in which the lock command corresponds to a specific storage sector of the program memory 11.

Next, S402 is performed. The command processing module 15 recognizes which storage sector is the specific storage sector in accordance with the lock command.

Last, S404 is performed. The access lock module 13 is activated by the command processing module 15 for locking the specific storage sector. Then, the locked storage sector is able to keep the data stored therein from being dumped.

Before S400, the method further includes a step to input the lock command via the data inputting device 17.

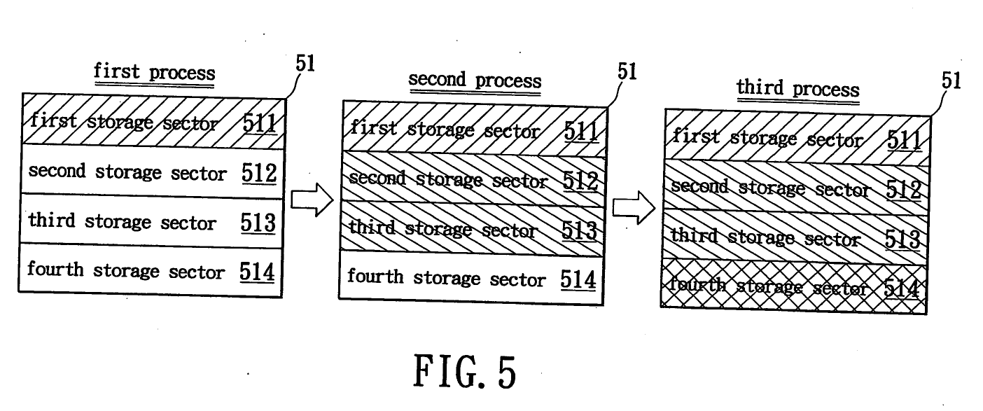

For explaining the advantage of the present invention, please refer to FIG. 5 that illustrates an example of applying the method and system for locking data of a program memory embedded in a microcontroller according to the present invention. As shown in FIG. 5, a program memory 51 is configured into four storage sectors, including a first storage sector 511, a second storage sector 512, a third storage sector 513, and a forth storage sector 514. Firmware is written into the storage sectors (511˜514) individually in the first process, the second process, and the third process. The processes are manufacturing procedures performed by different work stations.

As shown in FIG. 5, the first process writes data into the first storage sector 511. While the first process has been accomplished, the first storage sector 511 is locked and the second process is carried out. The second process writes data into the second storage sector 512 and the third storage sector 513. After the second process is accomplished, the second storage sector 512 is locked and the third process is carried out. After the third process is accomplished, the third storage sector 513 is locked. Then, the data can be written into the program memory 51 by different procedures. Otherwise, the data stored by the previous procedure will be impossible to be read out in the following steps. The product information, such as calibration reference and series number, can be stored in the storage sector without data locking. Then the product information can be read out through the interface of the microcontroller.

Therefore, through the embodiment illustrated above, one should realize that the method and system for locking data of a program memory embedded in a microcontroller according to the present invention configures the program memory into a plurality of storage sectors and the storage sectors can be locked individually. Thus the application of the microcontroller will be much more flexible and convenient. Furthermore, according to the present invention, the product information, such as calibration reference and series number, can be also stored in the program memory, so that it is not necessary to dispose external EEPROMs for storing the product information and reducing costs.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for locking data of a program memory embedded in a microcontroller, the program memory consisting of a one-time-programmable read only memory and being configured into a plurality of storage sectors, said method comprising the steps of:
receiving a lock command in which the lock command corresponds to a specific storage sector of the program memory;
according to the lock command, recognizing which storage sector is the specific storage sector; and
activating an access lock module for locking the specific storage sector; whereby the specific storage sector is able to keep the data stored therein from being dumped.

2. The method according to claim 1, wherein the access lock module comprises a plurality of locking circuits, and each locking circuit corresponds to one storage sector individually.

3. The method according to claim 2, wherein the locking circuits comprise at least one locking bit respectively and the state of the locking bit determines whether the storage sector is locked or not.

4. The method according to claim 3, wherein the locking bits belonging to the locking circuit are distributed onto the chip and the microcontroller is formed by an integrated circuit layout design so that the distribution of the locking bits cannot be recognized.

5. The method according to claim 2, wherein the step of activating the access lock module activates a specific locking circuit of the access lock module in which a specific locking circuit corresponds to the specific storage sector for keeping the data stored therein from being dumped.

6. The method according to claim 1, further comprising the step of importing the lock command via a data inputting device before the step of receiving the lock command.

7. A method for locking data of a program memory embedded in a microcontroller, the program memory consisting of a one-time-programmable read only memory and being configured into a plurality of storage sectors, said method comprising the steps of:
receiving a lock command in which the lock command corresponds to a specific storage sector of the program memory;
according to the lock command, recognizing which storage sector is the specific storage sector; and
activating an access lock module for locking the specific storage sector; wherein the access lock module comprises a plurality of locking circuits, each locking circuit corresponds to one storage sector individually and comprises at least one locking bit respectively, and the state of the locking bit determines whether the storage sector is locked or not;
whereby the specific storage sector is able to keep the data stored therein from being dumped.

8. The method according to claim 7, wherein the locking bits belonging to the locking circuit are distributed onto the chip and the microcontroller is formed via an integrated circuit layout design so that the distribution of the locking bits cannot be recognized.

9. The method according to claim 7, further comprising the step of importing the lock command via a data inputting device before the step of receiving the lock command.

10. A method for locking data of a program memory embedded in a microcontroller executed by a system for locking data of the program memory of the microcontroller, the system comprising a data inputting device and a microcontroller, the microcontroller comprising a program memory, an access lock module and a command processing module, the command processing module comprising a plurality of locking circuits, the program memory consisting of a one-time-programmable read only memory and being configured into a plurality of storage sectors, said method comprising the steps of:
the command processing module receiving a lock command generated from the data inputting device in which the lock command corresponds to a specific storage sector of the program memory;
according to the lock command, recognizing which storage sector is the specific storage sector; and
activating a specific locking circuit of the access lock module in which the specific locking circuit corresponds to the specific storage sector for keeping the data stored therein from being dumped.

11. The method according to claim 10, wherein the locking circuits comprises at least one locking bit respectively and the state of the locking bit determines whether the storage sector is locked or not.

12. The method according to claim 11, wherein the locking bits belonging to the locking circuit are distributed onto the chip and the microcontroller is formed via an integrated circuit layout design so that the distribution of the locking bits cannot be recognized.

13. A system for locking data of a program memory embedded in a microcontroller, said system comprising:
a data inputting device, generating a lock command; and
a microcontroller, coupled to the data inputting device, said microcontroller comprising:
a program memory, consisting of a one-time-programmable read only memory, said program memory being configured into a plurality of storage sectors;
an access lock module, coupled to the program memory; and
a command processing module, coupled to the access lock module; wherein the command processing module receives the lock command generated from the data inputting device in which the lock command corresponds to a specific storage sector of the program memory, the command processing module recognizes the specific storage sector in accordance with the lock command, and the command processing module further activates the access lock module for locking the specific storage sector for keeping the data stored therein from being dumped.

14. The system according to claim 13, wherein the access lock module comprises a plurality of locking circuits, each locking circuit corresponds to one storage sector individually, and the access lock module activates a specific locking circuit corresponding to the specific storage sector for keeping the data stored therein from being dumped.

15. The system according to claim 14, wherein the locking circuit comprises at least one locking bit respectively and the state of the locking bit determines whether the storage sector is locked or not.

16. The system according to claim 15, wherein the locking bit consists of a one-time-programmable read only memory.

17. The system according to claim 15, wherein the locking bits belonging to the locking circuit are distributed onto the chip and the microcontroller is formed via an integrated circuit layout design so that the distribution of the locking bits cannot be recognized.

18. The system according to claim 14, wherein the access lock module further comprises an all-sector locking circuit, and the activation of the all-sector locking circuit locks all storage sectors for keeping the data stored therein from being dumped.

19. A microcontroller, comprising:
a program memory, consisting of a one-time-programmable read only memory, said program memory being configured into a plurality of storage sectors;
an access lock module, coupled to the program memory; and
a command processing module, coupled to the access lock module;
wherein the command processing module receives a lock command in which the lock command corresponds to a specific storage sector of the program memory, the command processing module recognizes the specific storage sector in accordance with the lock command, and the command processing module further activates the access lock module for locking the specific storage sector for keeping the data stored therein from being dumped.

20. The microcontroller according to claim 19, wherein the lock command is generated from a data inputting device.

21. The microcontroller according to claim 19, wherein the access lock module comprises a plurality of locking circuits, each locking circuit corresponds to one storage sector individually, and the access lock module activates a specific locking circuit corresponding to the specific storage sector for keeping the data stored therein from being dumped.

22. The microcontroller according to claim 21, wherein the locking circuit comprises at least one locking bit respectively and the state of the locking bit determines whether the storage sector is locked.

23. The microcontroller according to claim 22, wherein the locking bit consists of a one-time-programmable read only memory.

24. The microcontroller according to claim 22, wherein the locking bits belonging to the locking circuit are distributed onto the chip and the microcontroller is formed via an integrated circuit layout design so that the distribution of the locking bits cannot be recognized.

25. The microcontroller according to claim 21, wherein the access lock module further comprises an all-sector locking circuit, and the activation of the all-sector locking circuit locks all storage sectors for keeping the data stored therein from being dumped.
